(19) United States
(12) Patent Application Publication
(10) Pub. No.: US 2011/0294064 A1
(43) Pub. Date: Dec. 1, 2011

(54) TONER, METHOD OF MANUFACTURING TONER, DEVELOPER, IMAGE FORMING METHOD, AND IMAGE FORMING APPARATUS

(76) Inventors: Azumi MIYAAKE, Chiba (JP); Hideki Sugiura, Shizuoka (JP); Yuka Mizoguchi, Shizuoka (JP)

(21) Appl. No.: 13/106,150

(22) Filed: May 12, 2011

(30) Foreign Application Priority Data
May 28, 2010 (JP) 2010-123421
Apr. 22, 2011 (JP) 2011-096481

(51) Int. Cl. G03G 9/087; G03G 13/20; G03G 15/08; G03G 9/12

(52) U.S. Cl. 430/109.4; 430/137.22; 430/124.1; 399/252

(57) ABSTRACT

A toner comprising a colorant, a release agent, an amorphous polyester, and a crystalline polyester having an endothermic peak temperature of 60 to 80° C. and an endothermic quantity of 3.0 to 20.0 J/g. The endothermic peak temperature is determined from a constant rate component curve of the crystalline polyester obtained in a second heating of temperature-modulated differential scanning calorimetry. The endothermic quantity is determined from an area between the constant rate component curve and its base line drawn between 0 and 100° C., within a temperature range of 0 to 50° C.

### CROSS-REFERENCE TO RELATED APPLICATIONS

The present patent application claims priority pursuant to 35 U.S.C. §119 from Japanese Patent Application Nos. 2010-123421 and 2011-096481, filed on May 28, 2010 and Apr. 22, 2011, respectively, each of which is hereby incorporated by reference herein in its entirety.

### BACKGROUND

1. Field of the Invention

The present invention relates to a toner, a method of manufacturing toner, a developer, an image forming method, and an image forming apparatus.

2. Description of the Background

In an electrophotographic or electrostatic image forming apparatus, an electrostatic latent image is formed on a photoreceptor and is developed into a toner image. The toner image is then transferred onto a recording medium and fixed on it by heat. A full-color image is formed by superimposing toner images of black, yellow, magenta, and cyan on a recording medium and fixing them on the recording medium by heat.

To meet increasing demands for energy saving and high quality printing, toners are required to be fixable at much lower temperatures while keeping heat-resistant storage stability.

International Patent Application Publication No. WO 2006/035862 describes a toner comprising an amorphous polyester resin and a crystalline polyester resin as binder resins. This toner provides a specific DSC curve measured by a differential scanning calorimeter, in which the onset temperature of a starting point is 100-150° C. and that of a terminating point is 150-200° C. in heating, and a heat absorbing peak having a half width of 10-40° C. is present.

But this toner is likely to adhere to components or parts of the image forming apparatus and undesirably form its film. This phenomenon is hereinafter referred to as filming.

### SUMMARY

Exemplary aspects of the present invention are put forward in view of the above-described circumstances, and provide a toner having good combination of low-temperature fixability, heat-resistant storage stability, and filming resistance; a manufacturing method of the toner; a developer including the toner; an image forming method using the toner; and an image forming apparatus including the toner.

In one exemplary embodiment, a novel toner comprises a colorant, a release agent, an amorphous polyester, and a crystalline polyester having an endothermic peak temperature of 60 to 80° C. and an endothermic quantity of 3.0 to 20.0 J/g. The endothermic peak temperature is determined from a constant rate component curve of the crystalline polyester obtained in a second heating of temperature-modulated differential scanning calorimetry. The endothermic quantity is determined from an area between the constant rate component curve and its base line drawn between 0 and 100° C., within a temperature range of 0 to 50° C.

In another exemplary embodiment, a novel method of manufacturing toner includes dissolving or dispersing toner components comprising the colorant, release agent, amorphous polyester, and crystalline polyester in an organic solvent to prepare a first liquid; emulsifying or dispersing the first liquid in an aqueous medium including a particulate resin to prepare a second liquid; and removing the organic solvent from the second liquid. The amorphous polyester is alternatively obtainable from a reaction between a polyester prepolymer having an isocyanate group and a compound having an amino group.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a graph showing a curve of a constant rate component (i.e., reversing heat flow) obtained in the second heating of temperature-modulated differential scanning calorimetry;

FIG. 2 is a graph showing a differential scanning calorimetric curve obtained in the first heating of temperature-modulated differential scanning calorimetry;

FIG. 3 schematically illustrates an image forming apparatus according to exemplary aspects of the invention; and

FIG. 4 is a magnified view of two of the image forming units illustrated in FIG. 3.

### DETAILED DESCRIPTION

Exemplary aspects of the invention provides a toner comprising a colorant, a release agent, an amorphous polyester, and a crystalline polyester having an endothermic peak temperature of 60 to 80° C., preferably 65 to 75° C., and an endothermic quantity of 3.0 to 20.0 J/g, preferably 5 to 15 J/g. The endothermic peak temperature is determined from a constant rate component curve of the crystalline polyester obtained in the second heating of temperature-modulated differential scanning calorimetry, and the endothermic quantity is determined from the area between the constant rate component curve and its base line drawn between 0 and 100° C., within a temperature range of 0 to 50° C. The crystalline polyester rapidly reduces its viscosity at around the endothermic peak temperature.

When the endothermic peak temperature of the crystalline polyester is too low, heat-resistant storage stability and filming resistance of the toner may be poor. When the endothermic peak temperature of the crystalline polyester is too high, low-temperature fixability of the toner may be poor. When the endothermic quantity of the crystalline polyester is too large, heat-resistant storage stability of the toner may be poor. When the endothermic peak temperature is above 85° C., it is difficult to make the endothermic quantity above 4 J/g. When the endothermic temperature is below 55° C., it is difficult to make the endothermic quantity below 20 J/g.

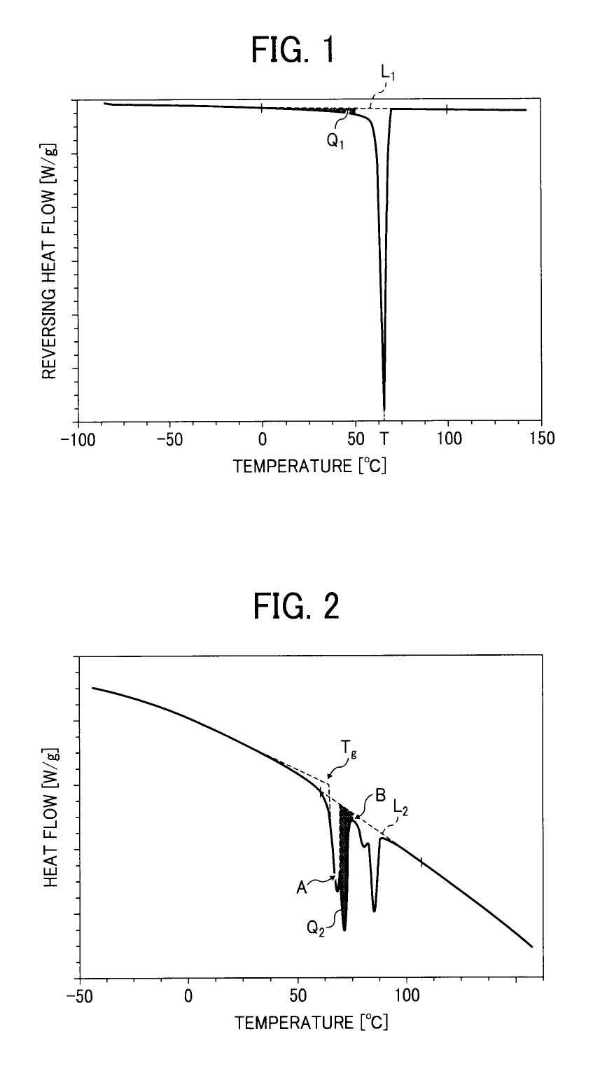

To determine the endothermic peak temperature and endothermic quantity, the crystalline polyester is subjected to temperature-modulated differential scanning calorimetry using a differential scanning calorimeter Q200 (from TA Instruments) as follows. First, about 5.0 mg of a sample (i.e., the crystalline polyester) is contained in a specimen container and set in an electric furnace with a holder unit. Under nitrogen atmosphere, the sample is heated from −90 to 150° C. at a heating rate of 3° C./min and a modulating period of 0.5° C./min. (This process is hereinafter referred to as the first heating.) Subsequently, the sample is cooled to −90° C. at a cooling rate of 20° C./min. Thereafter, the sample is reheated from −90 to 150° C. at a heating rate of 3° C./min and a modulating period of 0.5° C./min. (This process is hereinafter referred to as the second heating.) FIG. 1 is a graph showing a curve of a constant rate component (i.e., reversing heat flow) obtained in the second heating. This curve is analyzed with an analysis program TA Universal Analysis (from TA Instruments) to determine the endothermic peak temperature T and endothermic quantity Q1. The endothermic quantity Q1 is determined from the area between the constant rate component curve and its base line L1 drawn between 0 and 100° C., within a temperature range of 0 to 50° C.

Preferably, the toner has a glass transition temperature of 45 to 65° C. The glass transition temperature is determined from a differential scanning calorimetric curve (hereinafter “DSC curve”) of the toner obtained in the first heating of temperature-modulated differential scanning calorimetry. When the glass transition temperature of the toner is too low, heat-resistant storage stability of the toner may be poor. When the glass transition temperature of the toner is too high, low-temperature fixability of the toner may be poor.

The glass transition temperature can be adjusted by manufacturing the toner by dissolving or dispersing toner components comprising the colorant, release agent, amorphous polyester, and crystalline polyester in an organic solvent, and emulsifying or dispersing the resulting toner components liquid in an aqueous medium, while controlling conditions of the toner components liquid.

The toner preferably comprises resin particles on its surface for the purpose of controlling surface hardness and fixability.

Specific preferred examples of suitable resins for the resin particles include, but are not limited to, vinyl resins, polyurethane, epoxy resins, polyester, polyamide, polyimide, silicone resins, phenol resins, melamine resins, urea resins, aniline resins, ionomer resins, and polycarbonate. Two or more of these resins can be used in combination. Among the above resins, vinyl resins, polyurethane, epoxy resins, and polyester are preferable because they can be easily formed into fine spherical particles.

Specific examples of suitable vinyl resins include, but are not limited to, styrene-acrylate copolymer, styrene-methacrylate copolymer, styrene-butadiene copolymer, acrylic acid-acrylate copolymer, methacrylic acid-acrylate copolymer, styrene-acrylonitrile copolymer, styrene-maleic anhydride copolymer, styrene-acrylic acid copolymer, and styrene-methacrylic acid copolymer. Among these vinyl resins, styrene-butyl methacrylate copolymer is preferable.

The resin particles preferably have a glass transition temperature of 40 to 100° C. and a weight average molecular weight of 9×10³ to 2×10⁵. When the glass transition temperature or weight average molecular weight of the resin particles is too low, heat-resistant storage stability of the toner may be poor. When the glass transition temperature or weight average molecular weight of the resin particles is too high, low-temperature fixability of the toner may be poor.

The content of the resin particles in the toner is preferably 0.5 to 5.0% by weight. When the content of the resin particles is too low, it may be difficult to control surface hardness and fixability of the toner. When the content of the resin particles is too high, the resin particles may prevent the release agent from exuding from the toner, possibly causing undesirable toner offset.

The content of the resin particles in the toner is calculated by comparing peak areas of the resin particles and the binder resins measured by a pyrolysis gas chromatography mass spectrometer.

Preferably, the crystalline polyester absorbs 5.0 to 50.0 J/g of heat when the toner is heated at a heating rate of 1° C./min in a first heating of temperature-modulated differential scanning calorimetry. The heat absorbed by the crystalline polyester in the toner appears as an endothermic peak present between 55 and 78° C. in a DSC curve of the toner. By contrast, as described previously, when the crystalline polyester is heated alone, an endothermic peak is preferably present between 60 and 80° C. Thus, the crystalline polyester dissolves with the amorphous polyester or alters its crystallinity when included in the toner and reduce its endothermic peak temperature. Additionally, it is likely that endothermic peak temperatures get much lower as the heating rate gets much slower, i.e., 1° C./min.

When heat absorbed by the crystalline polyester in the first heating of temperature-modulated differential scanning calorimetry of the toner at a heating rate of 1° C./min is too small, low-temperature fixability of the toner may be poor. When heat absorbed by the crystalline polyester in the first heating of temperature-modulated differential scanning calorimetry of the toner at a heating rate of 1° C./min is too large, filming resistance of the toner may be poor.

To determine the glass transition temperature and the heat absorbed by the crystalline polyester, the toner is subjected to temperature-modulated differential scanning calorimetry using a differential scanning calorimeter Q200 (from TA Instruments) as follows. First, about 5.0 mg of a sample (i.e., the toner) is contained in a specimen container and set in an electric furnace with a holder unit. Under nitrogen atmosphere, the sample is heated from −20 to 150° C. at a heating rate of 1° C./min and a modulating period of 0.159° C./min. (This process is hereinafter referred to as the first heating.) FIG. 2 is a graph showing a differential scanning calorimetric curve (hereinafter “DSC curve”) obtained in the first heating. This curve is analyzed with an analysis program TA Universal Analysis (from TA Instruments) to determine the glass transition temperature Tg by detecting inflection points. The endothermic quantity Q2 absorbed by the crystalline polyester is determined from the area between the DSC curve and its base line L2, within a range between a boundary A between endothermic peaks of the crystalline polyester and the release agent and a boundary B between the endothermic peak of the crystalline polyester and a relaxation peak of the amorphous polyester.

The crystalline polyester is preferably obtained from saturated aliphatic diols having 2 to 12 carbon atoms (i.e., alcohol components) such as 1,4-butanediol, 1,6-hexanediol, 1,8-octanediol, 1,10-decanediol, 1,12-dodecanediol, and derivatives thereof.

Additionally, the crystalline polyester is preferably obtained from dioic acids having 2 to 12 carbon atoms (i.e., acid components) such as fumaric acid, 1,4-butanedioic acid, 1,6-hexanedioic acid, 1,8-octanedioic acid, 1,10-decanedioic acid, 1,12-dodecanedioic acid, and derivatives thereof.

Accordingly, the crystalline polyester is preferably a polycondensation product of at least of one of 1,4-butanediol, 1,6-hexanediol, 1,8-octanediol, 1,10-decanediol, and 1,12-dodecanediol with at least one of 1,4-butanedioic acid, 1,6-hexanedioic acid, 1,8-octanedioic acid, 1,10-decanedioic acid, and 1,12-dodecanedioic acid.

Preferably, the amorphous polyester is a urea-modified polyester. The urea-modified polyester can be obtained by reacting a polyester prepolymer having an isocyanate group with a compound having an amino group. The polyester prepolymer having an isocyanate group can be obtained by reacting a polycondensation product of a polyol with a polycarboxylic acid, with a polyisocyanate.

Specific examples of suitable polyols include, but are not limited to, diols such as alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclic diols (e.g., 1,4-cyclohexanedimethanol, hydrogenated bisphenol A), alkylene oxide (e.g., ethylene oxide, propylene oxide, butylene oxide) adducts of the alicyclic diols, bisphenols (e.g., bisphenol A, bisphenol F, bisphenol S), and alkylene oxide (e.g., ethylene oxide, propylene oxide, butylene oxide) adducts of the bisphenols; and polyols having 3 or more valences such as polyvalent aliphatic alcohols having 3 or more valences (e.g., glycerin, trimethylolethane, trimethylolpropane, pentaerythritol, sorbitol), polyphenols having 3 or more valences (e.g., trisphenol PA, phenol novolac, cresol novolac), and alkylene oxide (e.g., ethylene oxide, propylene oxide, butylene oxide) adducts of the polyphenols having 3 or more valences. Two or more of these polyols can be used in combination. Among these polyols, diols and mixtures of a diol with a polyol having 3 or more valences are preferable; alkylene glycols having 2 to 12 carbon atoms and alkylene oxide adducts of bisphenols are more preferable; and alkylene oxide adducts of bisphenols and mixtures of an alkylene oxide adduct of a bisphenol and an alkylene glycol having 2 to 12 carbon atoms are more preferable.

Specific examples of suitable polycarboxylic acids include, but are not limited to, dicarboxylic acids such as alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalenedicarboxylic acid); and polycarboxylic acids having 3 or more valences such as aromatic polycarboxylic acids (e.g., trimellitic acid, pyromellitic acid). Two or more of these polycarboxylic acids can be used in combination. Among these polycarboxylic acids, dicarboxylic acids and mixtures of a dicarboxylic acid and a polycarboxylic acid having 3 or more valences are preferable; and alkenylene dicarboxylic acids having 4 to 20 carbon atoms and aromatic dicarboxylic acids having 8 to 20 carbon atoms are more preferable.

Additionally, anhydrides and lower alkyl esters (e.g., methyl ester, ethyl ester, isopropyl ester) of the above-described polycarboxylic acids are also usable.

The polyol and the polycarboxylic acid are subjected to polycondensation by being heated to 150 to 280° C. in the presence of an esterification catalyst (e.g., tetrabutoxy titanate, dibutyltin oxide), while optionally reducing pressure and removing the produced water.

The equivalent ratio of hydroxyl groups in the polyol to carboxyl groups in the polycarboxylic acid is preferably 1 to 2, more preferably 1 to 1.5, and most preferably 1.02 to 1.3.

Specific examples of suitable polyisocyanates include, but are not limited to, aliphatic polyisocyanates (e.g., tetramethylene diisocyanate, hexamethylene diisocyanate, 2,6-diisocyanatomethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), and isocyanurates. Two or more of these polyisocyanates can be used in combination.

The isocyanate groups in the above polyisocyanates can be blocked with a phenol derivative, an oxime, or a caprolactam.

The polycondensation products of the polyol and polycarboxylic acid is reacted with the polyisocyanate at 40 to 140° C.

The equivalent ratio of isocyanate groups in the polyisocyanate to hydroxyl groups in the polycondensation product of the polyol and polycarboxylic acid is preferably 1 to 5, more preferably 1.2 to 4, and most preferably 1.5 to 2.5. When the equivalent ratio is too small, hot offset resistance of the toner may be poor. When the equivalent ratio is too large, low-temperature fixability of the toner may be poor.

The polyester prepolymer having an isocyanate group preferably includes the polyisocyanate units in an amount of 0.5 to 40% by weight, more preferably 1 to 30% by weight, and most preferably 2 to 20% by weight. When the amount is too small, hot offset resistance, heat-resistant storage stability, and low-temperature fixability of the toner may be poor. When the amount is too large, low-temperature fixability of the toner may be poor.

The average number of isocyanate groups included in one molecule of the polyester prepolymer is preferably 1 or more, more preferably 1.5 to 3, and most preferably 1.8 to 2.5. When the number of isocyanate groups per molecule is too small, hot offset resistance of the toner may be poor because the molecular weight of the resulting urea-modified polyester is too small.

Specific examples of suitable compounds having an amino group include, but are not limited to, diamines such as aromatic diamines (e.g., phenylenediamine, diethyltoluenediamine, 4,4′-diaminodiphenylmethane), alicyclic diamines (e.g., 4,4′-diamino-3,3′-dimethyldicyclohexylmethane, diaminocyclohexane, isophoronediamine), and aliphatic diamines (e.g., ethylenediamine, tetramethylenediamine, hexamethylenediamine); polyamines having 3 or more valences (e.g., diethylenetriamine, triethylenetetramine); amino alcohols (e.g., ethanolamine, hydroxyethylaniline); amino mercaptans (e.g., aminoethyl mercaptan, aminopropyl mercaptan); and amino acids (e.g., aminopropionic acid, aminocaproic acid). Among these compounds, diamines and mixtures of a diamine and a polyamine having 3 or more valences are preferable.

Additionally, ketimines in which amino groups are blocked with a ketone (e.g., acetone, methyl ethyl ketone, methyl isobutyl ketone) and oxazolines in which amino groups are blocked with an aldehyde are also usable as the compound having an amino group.

The equivalent ratio of isocyanate groups in the polyester prepolymer having an isocyanate group to amino groups in the compound having an amino group is preferably 0.5 to 2, more preferably 2/3 to 1.5, and most preferably 5/6 to 1.2. When the equivalent ratio is too small or large, hot offset resistance of the toner may be poor because the molecular weight of the resulting urea-modified polyester is too small.

The reaction between the polyester prepolymer having an isocyanate group and the compound having an amino group can be terminated with a reaction terminator to control the molecular weight of the resulting urea-modified polyester.

Specific preferred examples of suitable reaction terminators include, but are not limited to, monoamines (e.g., diethylamine, dibutylamine, butylamine, laurylamine).

Additionally, ketimines in which amino groups are blocked with a ketone (e.g., acetone, methyl ethyl ketone, methyl isobutyl ketone) and oxazolines in which amino groups are blocked with an aldehyde are also usable as the monoamine.

To more improve low-temperature fixability and gloss property, the urea-modified polyester can be used in combination with another amorphous polyester (hereinafter the “second amorphous polyester”). The second amorphous polyester may be a polycondensation product of a polyol with a polycarboxylic acid. The second amorphous polyester may be modified with a chemical bond other than urea bond, for example, a urethane bond.

It is preferable that the second amorphous polyester and the urea-modified polyester are at least partially compatible with each other, in other words, the second amorphous polyester and the urea-modified polyester have a similar structure, from the viewpoint of low-temperature fixability and hot offset resistance of the toner.

The weight ratio of the urea-modified polyester to the second amorphous polyester is preferably 5/95 to 75/25, more preferably 10/90 to 25/75, much more preferably 12/88 to 25/75, and most preferably 12/88 to 22/78. When the weight ratio is too small, hot offset resistance, heat-resistant storage stability, and low-temperature fixability of the toner may be poor. When the weight ratio is too large, low-temperature fixability of the toner may be poor.

The second amorphous polyester preferably has a peak molecular weight of 1×10³ to 3×10⁴, more preferably 1.5×10³ to 1×10⁴, and most preferably 2×10³ to 8×10³. When the peak molecular weight is too small, hot offset resistance of the toner may be poor. When the peak molecular weight is too large, low-temperature fixability of the toner may be poor.

The second amorphous polyester preferably has a hydroxyl value of 5 mgKOH/g or more, more preferably 10 to 120 mgKOH/g, and most preferably 20 to 80 mgKOH/g. When the hydroxyl value is too small, heat-resistant storage stability and low-temperature fixability of the toner may be poor.

The second amorphous polyester preferably has an acid value of 40 mgKOH/g or less, and more preferably 5 to 35 mgKOH/g, so that the toner is negatively chargeable. When the acid value is too large, the resulting image quality may be deteriorated under high-temperature and high-humidity conditions or low-temperature and low-humidity conditions.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. Two or more of these colorants can be used in combination.

The content of the colorant in the toner is preferably 1 to 15% by weight, and more preferably 3 to 10% by weight. When the content of the colorant is too small, coloring power of the toner may be poor. When the content of the colorant is too large, the colorant may prevent the toner from normal fixing on a recording medium.

The colorant can be combined with a resin to be used as a master batch.

Specific examples of usable resin for the master batch include, but are not limited to, polymers of styrene or styrene derivatives (e.g., polystyrene, poly-p-chlorostyrene, polyvinyl toluene), styrene-based copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. Two or more of these resins can be used in combination.

The master batch can be prepared by mixing or kneading one or more of the above-described resins and the above-described colorant, while optionally adding an organic solvent to increase the interaction between the colorant and the resin. In addition, the master batch is preferably prepared by a flushing method in which an aqueous paste of a colorant, a resin, and an organic solvent are mixed or kneaded so that the colorant is transferred to the resin side, followed by removal of the organic solvent and moisture. This method is advantageous in that a wet cake of a colorant can be used as it is without being dried.

When performing the mixing or kneading, a high shearing force dispersing device such as a three roll mill can be preferably used.

Specific examples of usable release agents include, but are not limited to, polyolefin waxes (e.g., polyethylene wax, polypropylene wax), long-chain hydrocarbons (e.g., paraffin wax, SASOL wax), and carbonyl-group-containing waxes. Two or more of these release agents can be used in combination. Among these release agents, carbonyl-group-containing waxes are preferable.

Specific examples of the carbonyl-group-containing waxes include, but are not limited to, polyalkanoic acid esters (e.g., carnauba wax, montan wax, trimethylolpropane tribehenate, pentaerythritol tetrabehenate, pentaerythritol diacetate dibehenate, glycerin tribehenate, 1,18-octadecanediol distearate), polyalkanol esters (e.g., tristearyl trimellitate, distearyl maleate), polyalkanoic acid amides (e.g., ethylenediamine dibehenylamide), polyalkyl amides (e.g., trimellitic acid tristearylamide), and dialkyl ketones (e.g., distearyl ketone). Among these carbonyl-group-containing waxes, polyalkanoic acid esters are preferable.

The release agent preferably has a melting point of 40 to 160° C., more preferably 50 to 120° C., and most preferably 60 to 90° C. When the melting point is too small, heat-resistant storage stability of the toner may be poor. When the melting point is too large, low-temperature fixability of the toner may be poor.

The release agent preferably has a melt viscosity of 5 to 1,000 cps, more preferably 10 to 100 cps, at 20° C. above the melting point. When the melting viscosity at 20° C. above the melting point is too small, heat-resistant storage stability of the toner may be poor. When the melting viscosity at 20° C. above the melting point is too large, low-temperature fixability of the toner may be poor.

The content of the release agent in the toner is preferably 0 to 40% by weight, and more preferably 3 to 30% by weight.

The toner may further include a charge controlling agent.

Specific preferred examples of suitable charge controlling agents include, but are not limited to, nigrosine dyes, triphenylmethane dyes, chrome-containing metal complex dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine-containing surfactants, metal salts of salicylic acid, metal salts of salicylic acid derivatives, copper phthalocyanine, perylene, quinacridone, azo pigments, polymers containing functional groups such as sulfonic acid group, carboxyl group, and quaternary ammonium salt.

Specific examples of commercially available charge controlling agents include, but are not limited to, BONTRON® 03 (nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complexes of quaternary ammonium salts), which are manufactured by Hodogaya Chemical Co., Ltd.; COPY CHARGE® PSY VP2038 (quaternary ammonium salt), COPY BLUE® PR (triphenylmethane derivative), COPY CHARGE® NEG VP2036 and COPY CHARGES NX VP434 (quaternary ammonium salts), which are manufactured by Hoechst AG; LRA-901, and LR-147 (boron complex), which are manufactured by Japan Carlit Co., Ltd.

The charge controlling agent may be mixed or kneaded with the colorant in preparing the master batch, or directly fixed on the surface of the resulting toner particles.

The content of the charge controlling agent is preferably 0.1 to 10% by weight, and more preferably 0.2 to 5% by weight, based on the binder resin. When the content of the charge controlling agent is too small, chargeability of the toner may be poor. When the content of the charge controlling agent is too large, the electrostatic attractive force between the toner and a developing roller is excessively increased, resulting in poor fluidity of the toner and low image density.

The toner may further include a fluidity improving agent and/or a cleanability improving agent fixed on its surface.

Specific preferred examples of suitable fluidity improving agents include, but are not limited to, silica, alumina, titania, barium titanate, magnesium titanate, calcium titanate, strontium titanate, iron oxide, copper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Among these materials, silica and titania are preferable.

Specific examples of commercially available silica particles include, but are not limited to, HDK H 2000, HDK H 2000/4, HDK H 2050EP, HVK 21, and HDK H 1303 (from Hoechst AG); and R972, R974, RX200, RY200, R202, R805, and R812 (from Nippon Aerosil Co., Ltd.).

Specific examples of commercially available titania particles include, but are not limited to, P-25 (from Nippon Aerosil Co., Ltd.); STT-30 and STT-65C-S (from Titan Kogyo, Ltd.); TAF-140 (from Fuji Titanium Industry Co., Ltd.); and MT-150W, MT-500B, MT-600B, and MT-150A (from TAYCA Corporation).

Preferably, the surface of the fluidity improving agent is hydrophobized with a surface treatment agent. The hydrophobized fluidity improving agent prevents deterioration of fluidity and chargeability of the toner even under high-humidity conditions.

Specific preferred examples of suitable surface treatment agents include, but are not limited to, silane coupling agents, silylation agents, silane coupling agents having a fluorinated alkyl group, organic titanate coupling agents, aluminum coupling agents, and silicone oils.

Specific examples of usable silane coupling agents include, but are not limited to, methyltrimethoxysilane, methyltriethoxysilane, and octyltrimethoxysilane.

Specific examples of usable silicone oils include, but are not limited to, dimethyl silicone oil, methyl phenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether-modified silicone oil, phenol-modified silicone oil, carboxyl-modified silicone oil, mercapto-modified silicone oil, acrylic-modified or methacrylic-modified silicone oil, and α-methylstyrene-modified silicone oil.

Specific examples of commercially available hydrophobized titania particles include, but are not limited to, T-805 (from Nippon Aerosil Co., Ltd.); STT-30A and STT-65S-S (from Titan Kogyo, Ltd.); TAF-500T and TAF-1500T (from Fuji Titanium Industry Co., Ltd.); MT-100S and MT-100T (from TAYCA Corporation); and IT-S (from Ishihara Sangyo Kaisha, Ltd.).

Primary particles of the fluidity improving agent preferably have an average diameter of 1 to 100 nm, and more preferably 50 to 70 nm.

The fluidity improving agent preferably has a BET specific surface of 20 to 500 m²/g.

The content of the fluidity improving agent in the toner is preferably 0.1 to 5% by weight, and more preferably 0.3 to 3% by weight.

Specific preferred examples of suitable cleanability improving agents include, but are not limited to, metal salts of fatty acids such as zinc stearate, calcium stearate, and aluminum stearate.

A temperature (TG′) at which the storage elastic modulus of the toner becomes 10,000 dyne/cm² at a frequency of 20 Hz is preferably 100° C. or more, more preferably 110 to 200° C. When the temperature (TG′) is too low, hot offset resistance of the toner may be poor.

A temperature (Tη) at which the viscosity of the toner becomes 1,000 poises at a frequency of 20 Hz is preferably 180° C. or less, more preferably 90 to 160° C. When the temperature (Tη) is too high, low-temperature fixability of the toner may be poor.

From the viewpoint of low-temperature fixability and hot offset resistance, TG′−Tη is preferably 0° C. or more, more preferably 10° C. or more, and most preferably 20° C. or more. From the viewpoint of heat-resistant storage stability and low-temperature fixability, the difference between Tη and Tg is preferably 0 to 100° C., more preferably 10 to 90° C., and most preferably 20 to 80° C.

The toner according to this specification can be manufactured by dissolving or dispersing toner components comprising a colorant, a release agent, a crystalline polyester, a polyester prepolymer having an isocyanate group, and a compound having an amino group in an organic solvent to prepare a first liquid; emulsifying or dispersing the first liquid in an aqueous medium including a particulate resin to prepare a second liquid; and removing the organic solvent from the second liquid.

The toner components may further include a second amorphous polyester and/or a charge controlling agent.

The toner components other than the resin components (i.e., the crystalline polyester and the polyester prepolymer having an isocyanate group) are not necessarily included in the first liquid. They can be added to the aqueous medium at the time or after the first liquid is emulsified or dispersed in the aqueous medium.

Specific examples of suitable organic solvents include, but are not limited to, toluene, ethyl acetate, butyl acetate, methyl ethyl ketone, and methyl isobutyl ketone. Two or more of organic solvents can be used in combination.

Preferably, the organic solvent does not dissolve the crystalline polyester at under (Tm-40)° C., and does dissolve the crystalline polyester at (Tm-40)° C. or above, wherein Tm represents the melting point of the crystalline polyester.

The first liquid is emulsified or dispersed in the aqueous medium using a low-speed shearing disperser, a high-speed shearing disperser, a frictional disperser, a high-pressure jet disperser, or an ultrasonic disperser, for example. A high-speed shearing disperser is preferable when controlling the particle diameter of the dispersing oil droplets into 2 to 20 μm.

As for the high-speed shearing disperser, the revolution is preferably 1×10³ to 3×10⁴ rpm, and more preferably 5×10³ to 2×10⁴ rpm. The dispersing time for a batch type is preferably 0.1 to 60 minutes. The dispersing temperature is preferably 0 to 80° C., and more preferably 10 to 40° C., under pressure.

The amount of the aqueous medium is preferably 100 to 1,000 parts by weight based on 100 parts by weight of the toner components. When the amount of the aqueous medium is too small, the resulting toner may not have a desired particle size. When the amount of the aqueous medium is too large, manufacturing cost may increase.

The aqueous medium may be comprised of water and the particulate resin dispersed therein. Additionally, a water-miscible solvent can be further mixed with water. Specific preferred examples of suitable water miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone).

The aqueous medium preferably includes a dispersant so that the resulting toner has a narrow size distribution.

Specific preferred examples of suitable dispersants include, but are not limited to, surfactants, poorly-water-soluble inorganic compounds, and polymeric protection colloids. Two or more of these materials can be used in combination. Among these materials, surfactants are preferable.

Surfactants include anionic surfactants, cationic surfactants, nonionic surfactants, and ampholytic surfactants.

Specific preferred examples of suitable anionic surfactants include, but are not limited to, alkylbenzene sulfonate, α-olefin sulfonate, and phosphate. In particular, anionic surfactants having a fluoroalkyl group are preferable.

Specific preferred examples of suitable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl) perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available anionic surfactants having a fluoroalkyl group include, but are not limited to, SURFLON® S-111, S-112, and S-113 (from AGC Seimi Chemical Co., Ltd.); FLUORAD FC-93, FC-95, FC-98, and FC-129 (from Sumitomo 3M); UNIDYNE DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific preferred examples of suitable cationic surfactants include, but are not limited to, amine salt type surfactants such as alkylamine salts, amino alcohol fatty acid derivatives, polyamine fatty acid derivatives, and imidazoline; and quaternary ammonium salt type surfactants (e.g., alkyl trimethyl ammonium salt, dialkyl dimethyl ammonium salt, alkyl dimethyl benzyl ammonium salt, pyridinium salt, alkyl isoquinolinium salt, and benzethonium chloride. In particular, cationic surfactants having a fluoroalkyl group are preferable.

Specific preferred examples of suitable cationic surfactants having a fluoroalkyl group include, but are not limited to, aliphatic primary, secondary, and tertiary amine acids having a fluoroalkyl group, aliphatic quaternary ammonium salts such as perfluoroalkyl(C6-C10) sulfonamide propyl trimethyl ammonium salts, benzalkonium salts, benzethonium chlorides, pyridinium salts, and imidazolinium salts.

Specific examples of commercially available cationic surfactants having a fluoroalkyl group include, but are not limited to, SURFLON® S-121 (from AGC Seimi Chemical Co., Ltd.); FLUORAD FC-135 (from Sumitomo 3M); UNIDYNE DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

Specific preferred examples of suitable nonionic surfactants include, but are not limited to, fatty acid amide derivatives and polyol derivatives.

Specific preferred examples of suitable ampholytic surfactants include, but are not limited to, alanine, dodecyl bis(aminoethyl) glycine, bis(octyl aminoethyl) glycine, and N-alkyl-N,N-dimethyl ammonium betaine.

Specific preferred examples of suitable poorly-water-soluble inorganic compounds include, but are not limited to, tricalcium phosphate, calcium carbonate, titanium oxide, colloidal silica, and hydroxyapatite.

In a case in which the aqueous medium includes acid-soluble or alkali-soluble compounds, for example, tricalcium phosphate, the resulting toner particles are first washed with an acid (e.g., hydrochloric acid) or an alkali to dissolve tricalcium phosphate and then washed with water. Alternatively, tricalcium phosphate can be decomposed with an enzyme.

Specific examples of usable polymeric protection colloids include, but are not limited to, homopolymers and copolymers obtained from monomers, such as carboxyl-group-containing monomers (e.g., acrylic acid, methacrylic acid, α-cyanoacrylic acid, α-cyanomethacrylic acid, itaconic acid, crotonic acid, fumaric acid, maleic acid, maleic anhydride), hydroxyl-group-containing acrylate and methacrylate monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate), vinyl alkyl ether monomers (e.g., vinyl methyl ether, vinyl ethyl ether, vinyl propyl ether), vinyl carboxylate monomers (e.g., vinyl acetate, vinyl propionate, vinyl butyrate), amide-group-containing acrylic or methacrylic monomers (e.g., acrylamide, methacrylamide, diacetone acrylamide), methylol compounds of the amide-group-containing acrylic or methacrylic monomers (e.g., N-methylol acrylamide, N-methylol methacrylamide), chlorides of carboxyl-group-containing acrylic or methacrylic monomers (e.g., acrylic acid chloride, methacrylic acid chloride), and/or monomers containing nitrogen or a nitrogen-containing heterocyclic ring (e.g., vinyl pyridine, vinyl pyrrolidone, vinyl imidazole, ethylene imine). Additionally, polyoxyethylene-based resins such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, and polyoxyethylene nonyl phenyl ester; and celluloses such as methyl cellulose, hydroxyethyl cellulose, and hydroxypropyl cellulose, are also usable as the polymeric protection colloids.

The aqueous medium may further include a catalyst that accelerates the reaction between the polyester prepolymer having an isocyanate group and the compound having an amino group.

Specific examples of usable catalysts include, but are not limited to, dibutyltin laurate and dioctyltin laurate.

The reaction time between the polyester prepolymer having an isocyanate group and the compound having an amino group in the second liquid is preferably 10 minutes to 40 hours, and more preferably 30 minutes to 24 hours. The reaction temperature is preferably 0 to 100° C., and more preferably 10 to 50° C.

The organic solvent can be removed from the second liquid by gradually heating the second liquid to completely evaporate the solvent. Alternatively, both the organic and aqueous solvents can be removed from the second liquid by spraying the second liquid into dry atmosphere to completely evaporate the solvent.

The dry atmosphere into which the second liquid is sprayed may be, for example, air, nitrogen gas, carbon dioxide gas, or combustion gas, which is heated above the maximum boiling point among the organic and aqueous solvents.

Such a treatment can be reliably performed by a spray drier, a belt drier, or a rotary kiln.

The removal of the solvents from the second liquid results in a dispersion in which toner particles are dispersed in the aqueous medium, or toner particles.

The dispersion in which toner particles are dispersed in the aqueous medium, or toner particles, is/are preferably washed with water and vacuum-dried, to remove the dispersant.

The toner particles can be subjected to a classification treatment to obtained desired-size particles, if necessary.

In the classification treatment, fine particles can be removed by a cyclone, a decanter, or a centrifugal separator, and coarse particles can be removed by a mesh.

The toner particles may be further mixed with other particles such as a fluidity improving agent and a cleanability improving agent.

A manufacturing method of the toner according to this specification is not limited to the method as described above. The toner can be also manufactured by other methods such as dissolution suspension methods and pulverization methods.

Exemplary aspects of the invention further provide a developer. The developer may be either a one-component developer comprising the toner according to this specification or a two-component developer comprising the toner and a carrier. The two-component developer preferably includes the toner in an amount of 1 to 10% by weight based on the carrier.

The carrier may be comprised of a core material and a resin layer that covers the core material.

Specific preferred examples of suitable core materials include, but are not limited to, iron powder, ferrite powder, magnetite powder, and magnetic resin carrier.

The core material preferably has an average particle diameter of 20 to 200 μm.

Specific preferred examples of suitable resins for the resin layer include, but are not limited to, amino resins (e.g., urea-formaldehyde resin, melamine resin, benzoguanamine resin, urea resin), polyamides, epoxy resins, vinyl resins (e.g., acrylic resin, polymethyl methacrylate, polyacrylonitrile, polyvinyl acetate, polyvinyl alcohol, polyvinyl butyral), styrene resins (e.g., polystyrene, styrene-acrylic copolymer), halogenated olefin resins (e.g., polyvinyl chloride), polyesters (e.g., polyethylene terephthalate, polybutylene terephthalate), polycarbonates, polyethylenes, fluorine-containing resins (e.g., polyvinyl fluoride, polyvinylidene fluoride, poly(trifluoroethylene), poly(hexafluoropropylene), vinylidene fluoride-acrylic copolymer, vinylidene fluoride-vinyl fluoride copolymer, tetrafluoroethylene-vinylidene fluoride-non-fluoride monomer terpolymer), and silicone resins.

The resin layer may include a conductive powder.

Specific preferred examples of suitable conductive powders include, but are not limited to, metal, carbon black, titanium oxide, tin oxide, and zinc oxide.

The conductive powder preferably has an average particle diameter of 1 μm or less. When the average particle diameter is too large, it may be difficult to control electric resistivity of the resin layer.

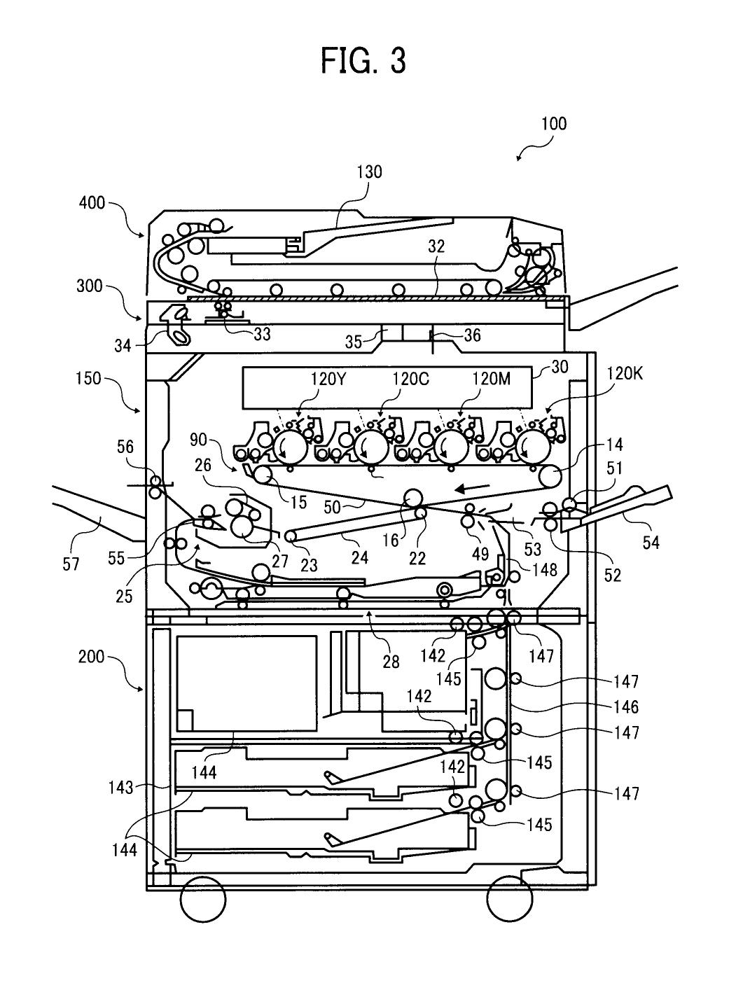

FIG. 3 schematically illustrates an image forming apparatus according to exemplary aspects of the invention. An image forming apparatus 100 is a tandem-type full-color image forming apparatus including a main body 150, a paper feed table 200, a scanner 300, and an automatic document feeder (ADF) 400.

An intermediate transfer belt 50 is provided in a center part of the main body 150. The intermediate transfer belt 50 is an seamless belt stretched taut with rollers 14, 15, and 16, and moves in the direction indicated by arrow in FIG. 3. A cleaning device 90 is provided in proximity to the roller 15. The cleaning device 90 includes a cleaning blade that removes residual toner particles remaining on the intermediate transfer belt 50 after a toner image is transferred onto a recording paper. Image forming units 120Y, 120C, 120M, and 120K (hereinafter collectively the “image forming units 120”) that form respective toner images of yellow, cyan, magenta, and cyan, are arranged facing the intermediate transfer belt 50 stretched between the rollers 14 and 15. An irradiator 30 is provided in proximity to the image forming units 120. A transfer belt 24 is provided on the opposite side of the image forming units 120 relative to the intermediate transfer belt 50. The transfer belt 24 is a seamless belt stretched taut with a pair of rollers 22 and 23. A recording paper conveyed on the transfer belt 24 is brought into contact with the intermediate transfer belt 50 at between the rollers 16 and 22. A fixing device 25 is provided in proximity to the transfer belt 24. The fixing device 25 includes a fixing belt 26 that is a seamless belt stretched taut with a pair of rollers and a pressing roller 27 pressed against the fixing belt 26. A sheet reversing device 28 for reversing recording papers in duplexing is provided in proximity to the transfer belt 24 and fixing device 25.

The image forming apparatus 100 produces a full-color image in the manner described below. A document is set on a document table 130 of the automatic document feeder 400. Alternatively, a document is set on a contact glass 32 of the scanner 300 while lifting up the automatic document feeder 400, followed by holding down of the automatic document feeder 400. Upon pressing of a switch, in a case in which a document is set on the contact glass 32, the scanner 300 immediately starts driving so that a first runner 33 and a second runner 34 start moving. In a case in which a document is set on the automatic document feeder 400, the scanner 300 starts driving after the document is fed onto the contact glass 32. The first runner 33 directs a light beam onto the document, and reflects a reflected light beam from the document toward the second runner 34. The second runner 34 further reflects the reflected light beam toward an imaging lens 35. The light beam passed through the imaging lens 35 is then received by a reading sensor 36 and image information of black, cyan, magenta, and yellow is read.

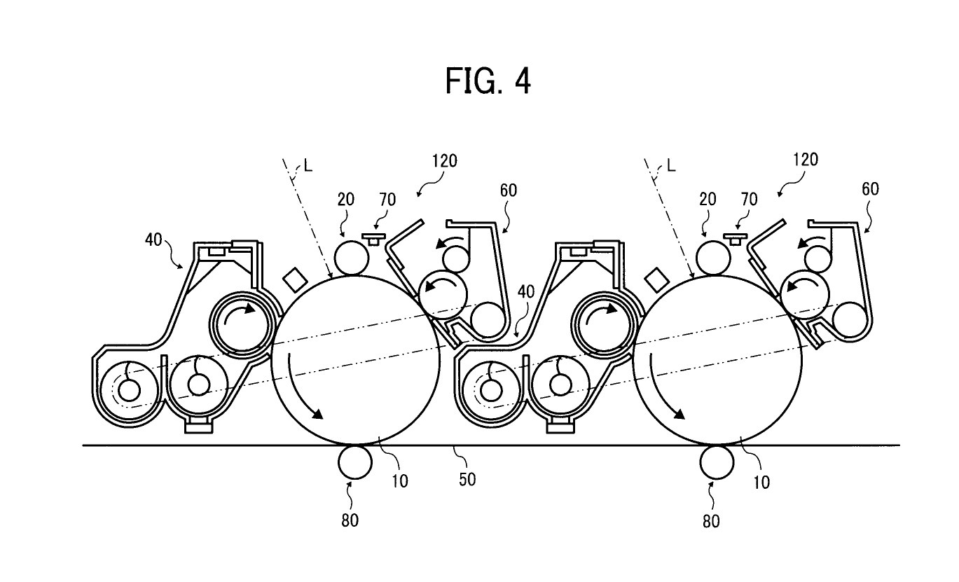

The image information is transmitted to the corresponding image forming units 120 to form toner images of respective colors. FIG. 4 is a magnified view of two of the image forming units 120. Each of the image forming units 120 includes a photoreceptor drum 10, a charging roller 20 that uniformly charges the photoreceptor drum 10, a developing device 40 that develops an electrostatic latent image into a toner image, a transfer roller 80 that transfers the toner image onto the intermediate transfer belt 50, a cleaning device 60 including a cleaning blade, and a neutralization lamp 70.

Toner images of four colors each formed in the image forming units 120 are sequentially transferred onto the intermediate transfer belt 50 that is endlessly moving, so that the toner images are superimposed on one another to form a composite toner image. (This process may be hereinafter referred to as the primary transfer.)

On the other hand, upon pressing of the switch, one of paper feed rollers 142 starts rotating in the paper feed table 200 so that a recording paper is fed from one of paper feed cassettes 144 in a paper bank 143. The recording paper is separated by one of separation rollers 145 and fed to a paper feed path 146. Feed rollers 147 feed the recording paper to a paper feed path 148 in the main body 150. The recording paper is stopped by a registration roller 49. Alternatively, a recording paper may be fed from a manual feed tray 54 by rotating a feed roller 51, separated by a separation roller 52, fed to a manual paper feed path 53, and stopped by the registration roller 49. Although the registration roller 49 is generally grounded, a bias is applicable to the registration roller 49 for the purpose of removing paper powders from the recording paper. The registration roller 49 feeds the recording paper to between the intermediate transfer belt 50 and the transfer belt 24 in synchronization with an entry of the composite full-color toner image formed on the intermediate transfer belt 50. (This process may be hereinafter referred to as the secondary transfer.) The cleaning device 90 removes residual toner particles remaining on the intermediate transfer belt 50 after the composite toner image is transferred onto the recording paper.

The transfer belt 24 conveys the recording paper having the composite toner image thereon to the fixing device 25 so that the composite toner image is fixed on the recording paper. A switch pick 55 switches paper feed paths so that the recording paper is discharged onto a discharge tray 57 by rotating a discharge roller 56. Alternatively, the switch pick 55 switches paper feed paths so that the recording paper is reversed by the sheet reversing device 28. After forming another toner image on the back side, the recording paper is discharged onto the discharge tray 57 by rotating the discharge roller 56.

The image forming apparatus 100 employs an indirect transfer method in which toner images are sequentially transferred onto the intermediate transfer belt 50 to form a composite toner image (i.e., primary transfer), and the composite toner image is then transferred onto a recording paper (i.e., secondary transfer). Exemplary aspects of the invention further provides an image forming apparatus employing a direct transfer method in which toner images are sequentially transferred onto a recording paper directly.

The transfer belt 24 may be replaced with a transfer roller.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation of Crystalline Polyesters

A 5-liter four-necked flask equipped with a nitrogen inlet pipe, a dewatering pipe, a stirrer, and a thermocouple is charged with 1,145 g of 1,8-octanedioic acid, 1,120 g of 1,8-octanediol, and 4.9 g of hydroquinone. The mixture is subjected to reaction for 10 hours at 180° C., subsequent 3 hours at 200° C., and further 2 hours at 8.3 kPa. Thus, a crystalline polyester 1 is prepared.

A 5-liter four-necked flask equipped with a nitrogen inlet pipe, a dewatering pipe, a stirrer, and a thermocouple is charged with 1,145 g of 1,8-octanedioic acid, 1,200 g of 1,8-octanediol, and 4.9 g of hydroquinone. The mixture is subjected to reaction for 10 hours at 180° C., subsequent 3 hours at 200° C., and further 2 hours at 8.3 kPa. Thus, a crystalline polyester 2 is prepared.

A 5-liter four-necked flask equipped with a nitrogen inlet pipe, a dewatering pipe, a stirrer, and a thermocouple is charged with 1,145 g of 1,10-decanedioic acid, 1,230 g of 1,10-decanediol, and 4.9 g of hydroquinone. The mixture is subjected to reaction for 10 hours at 180° C., subsequent 3 hours at 200° C., and further 2 hours at 8.3 kPa. Thus, a crystalline polyester 3 is prepared.

A 5-liter four-necked flask equipped with a nitrogen inlet pipe, a dewatering pipe, a stirrer, and a thermocouple is charged with 1,145 g of 1,6-hexanedioic acid, 1,150 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 4 is prepared.

A 5-liter four-necked flask equipped with a nitrogen inlet pipe, a dewatering pipe, a stirrer, and a thermocouple is charged with 967 g of fumaric acid, 1,230 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 5 is prepared.

A 5-liter four-necked flask equipped with a nitrogen inlet pipe, a dewatering pipe, a stirrer, and a thermocouple is charged with 1,145 g of 1,8-octanedioic acid, 1,120 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 6 is prepared.

A 5-liter four-necked flask equipped with a nitrogen inlet pipe, a dewatering pipe, a stirrer, and a thermocouple is charged with 1,145 g of 1,8-octanedioic acid, 970 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 7 is prepared.

A 5-liter four-necked flask equipped with a nitrogen inlet pipe, a dewatering pipe, a stirrer, and a thermocouple is charged with 1,673 g of 1,10-decanedioic acid, 1,140 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 8 is prepared.

A 5-liter four-necked flask equipped with a nitrogen inlet pipe, a dewatering pipe, a stirrer, and a thermocouple is charged with 1,560 g of 1,10-decanedioic acid, 1,140 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 9 is prepared.

A 5-liter four-necked flask equipped with a nitrogen inlet pipe, a dewatering pipe, a stirrer, and a thermocouple is charged with 1,145 g of 1,12-dodecanedioic acid, 1,213 g of 1,10-decanediol, and 4.9 g of hydroquinone. The mixture is subjected to reaction for 9 hours at 180° C., subsequent 3 hours at 200° C., and further 2 hours at 8.3 kPa. Thus, a crystalline polyester 10 is prepared.

A 5-liter four-necked flask equipped with a nitrogen inlet pipe, a dewatering pipe, a stirrer, and a thermocouple is charged with 1,145 g of 1,12-dodecanedioic acid, 1,083 g of 1,10-decanediol, and 4.9 g of hydroquinone. The mixture is subjected to reaction for 9 hours at 180° C., subsequent 3 hours at 200° C., and further 2 hours at 8.3 kPa. Thus, a crystalline polyester 11 is prepared.

A 5-liter four-necked flask equipped with a nitrogen inlet pipe, a dewatering pipe, a stirrer, and a thermocouple is charged with 1,145 g of 1,10-decanedioic acid, 1,603 g of 1,12-dodecanediol, and 4.9 g of hydroquinone. The mixture is subjected to reaction for 9 hours at 180° C., subsequent 3 hours at 200° C., and further 2 hours at 8.3 kPa. Thus, a crystalline polyester 12 is prepared.

A 5-liter four-necked flask equipped with a nitrogen inlet pipe, a dewatering pipe, a stirrer, and a thermocouple is charged with 967 g of fumaric acid, 1,378 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 13 is prepared.

A 5-liter four-necked flask equipped with a nitrogen inlet pipe, a dewatering pipe, a stirrer, and a thermocouple is charged with 1,386 g of terephthalic acid, 500 g of 1,5-pentanediol, 567 g of 1,6-hexanediol, and 4.9 g of hydroquinone. The mixture is subjected to reaction for 10 hours at 180° C., subsequent 3 hours at 200° C., and further 2 hours at 8.3 kPa. Thus, a crystalline polyester 14 is prepared.

A 5-liter four-necked flask equipped with a nitrogen inlet pipe, a dewatering pipe, a stirrer, and a thermocouple is charged with 1,140 g of 1,6-hexanedioic acid, 1,425 g of 1,8-octanediol, and 4.9 g of hydroquinone. The mixture is subjected to reaction for 10 hours at 180° C., subsequent 3 hours at 200° C., and further 2 hours at 8.3 kPa. Thus, a crystalline polyester 15 is prepared.

Table 1 shows thermal properties of the above-prepared crystalline polyesters, i.e., endothermic peak temperatures determined from each constant rate component curve of each crystalline polyester obtained in the second heating of temperature-modulated differential scanning calorimetry, and endothermic quantities determined from each area between the constant rate component curve and its base line drawn between 0 and 100° C., within a temperature range of 0 to 50° C.

TABLE 1

| Crystalline | Endothermic peak | Endothermic |
|---|---|---|
| polyester No. | temperature (° C.) | quantity (J/g) |
| 1 | 65 | 12 |
| 2 | 63 | 17 |
| 3 | 70 | 5 |
| 4 | 53 | 30 |
| 5 | 85 | 0.2 |
| 6 | 62 | 25 |
| 7 | 62 | 7 |
| 8 | 68 | 10 |
| 9 | 67 | 15 |
| 10 | 79 | 3 |
| 11 | 78 | 6 |
| 12 | 74 | 13 |
| 13 | 85 | 3 |
| 14 | 75 | 1 |
| 15 | 57 | 18 |

### Preparation of Amorphous Polyesters

A reaction vessel equipped with a nitrogen inlet pipe, a dewatering pipe, a stirrer, and a thermocouple is charged with 290 parts of ethylene oxide 2 mol adduct of bisphenol A, 480 parts of propylene oxide 3 mol adduct of bisphenol A, 100 parts of isophthalic acid, 108 parts of terephthalic acid, 46 parts of adipic acid, and 2 parts of dibutyltin oxide. The mixture is subjected to reaction for 10 hours at 230° C. and subsequent 5 hours at 10 to 15 mmHg. After adding 30 parts of trimellitic anhydride, the mixture is further subjected to reaction for 3 hours at 180° C. Thus, an amorphous polyester 1 having a glass transition temperature of 48° C. is prepared.

A reaction vessel equipped with a nitrogen inlet pipe, a dewatering pipe, a stirrer, and a thermocouple is charged with 719 parts of propylene oxide 2 mol adduct of bisphenol A, 274 parts of terephthalic acid, 48 parts of adipic acid, and 2 parts of dibutyltin oxide. The mixture is subjected to reaction for 8 hours at 230° C. and normal pressures and subsequent 5 hours at 10 to 15 mmHg. After adding 8 parts of trimellitic anhydride, the mixture is further subjected to reaction for 2 hours at 180° C. and normal pressures. Thus, an amorphous polyester 2 having a glass transition temperature of 66° C. is prepared.

A reaction vessel equipped with a nitrogen inlet pipe, a dewatering pipe, a stirrer, and a thermocouple is charged with 229 parts of ethylene oxide 2 mol adduct of bisphenol A, 527 parts of propylene oxide 3 mol adduct of bisphenol A, 208 parts of terephthalic acid, 46 parts of isophthalic acid, and 2 parts of dibutyltin oxide. The mixture is subjected to reaction for 5 hours at 230° C. and normal pressures and subsequent 5 hours at 10 to 15 mmHg. After adding 44 parts of trimellitic anhydride, the mixture is further subjected to reaction for 2 hours at 180° C. and normal pressures. Thus, an amorphous polyester 3 having a glass transition temperature of 41° C. is prepared.

A reaction vessel equipped with a nitrogen inlet pipe, a dewatering pipe, a stirrer, and a thermocouple is charged with 220 parts of ethylene oxide 2 mol adduct of bisphenol A, 560 parts of propylene oxide 3 mol adduct of bisphenol A, 220 parts of terephthalic acid, 50 parts of adipic acid, and 3 parts of dibutyltin oxide. The mixture is subjected to reaction for 8 hours at 230° C. and normal pressures and subsequent 5 hours at 10 to 15 mmHg. After adding 40 parts of trimellitic anhydride, the mixture is further subjected to reaction for 3 hours at 180° C. and normal pressures. Thus, an amorphous polyester 4 having a glass transition temperature of 60° C. is prepared.

### Preparation of Polyester Prepolymer

A reaction vessel equipped with a nitrogen inlet pipe, a dewatering pipe, a stirrer, and a thermocouple is charged with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. The mixture is subjected to reaction for 7 hours at 230° C. and subsequent 5 hours at 10 to 15 mmHg. Thus, an intermediate polyester having a glass transition temperature of 54° C. is prepared.

Another reaction vessel equipped with a nitrogen inlet pipe, a dewatering pipe, a stirrer, and a thermocouple is charged with 410 parts of the intermediate polyester, 89 parts of isophorone diisocyanate, and 500 parts of ethyl acetate. The mixture is subjected to reaction for 5 hours at 100° C. Thus, a polyester prepolymer 1 is prepared. The polyester prepolymer 1 is including 1.53% by weight of free isocyanate groups.

### Preparation of Ketimine

A reaction vessel equipped with a stirrer and a thermometer is charged with 170 parts of isophoronediamine and 75 parts of methyl ethyl ketone. The mixture is subjected to reaction for 5 hours at 50° C. Thus, a ketimine 1 having an amine value of 418 mgKOH/g is prepared.

### Preparation of Particulate Resin

A reaction vessel equipped with a stirrer and a thermometer is charged with 683 parts of water, 11 parts of a sodium salt of a sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. The mixture is agitated for 15 minutes at a revolution of 400 rpm and then subjected to reaction for 5 hours at 75° C. Thereafter, 30 parts of a 1% aqueous solution of ammonium persulfate are added thereto, and the resulting mixture is aged for 5 hours at 75° C. Thus, a particulate resin dispersion 1 is prepared. Resin particles in the particulate resin dispersion 1 have a volume average particle diameter of 0.14 μm when measured by a laser diffraction particle size distribution analyzer LA-920 (from Horiba, Ltd.). The dried resin particles separated from the particulate dispersion 1 have a glass transition temperature of 72° C.

### Preparation of Aqueous Medium

An aqueous medium 1 is prepared by mixing 990 parts of water, 83 parts of the particulate resin dispersion 1, 37 parts of a 48.3% aqueous solution of dodecyl diphenyl ether sodium disulfonate (MON-7 from Sanyo Chemical Industries, Ltd.), and 90 parts of ethyl acetate.

### Example 1

First, 1,200 parts of water, 540 parts of a carbon black having a DBP oil absorption of 42 ml/100 g and a pH of 9.5 (PRINTEX 35 from Degussa), and 1,200 parts of the amorphous polyester 1 are mixed using a HENSCHEL MIXER (from Mitsui Mining and Smelting Co., Ltd.). The resulting mixture is kneaded for 3 hours at 150° C. using a double roll, the kneaded mixture is then rolled and cooled, and the rolled mixture is then pulverized into particles using a pulverizer. Thus, a master batch is prepared.

A vessel equipped with a stirrer and a thermometer is charged with 378 parts of the amorphous polyester 1, 100 parts of a carnauba wax, and 947 parts of ethyl acetate. The mixture is heated to 80° C. for 5 hours and cooled to 30° C. over a period of 1 hour. The mixture is further mixed with 500 parts of the master batch and 500 parts of ethyl acetate for 1 hour. Thereafter, 1,324 parts of the resulting mixture is subjected to a dispersion treatment using a bead mill (ULTRAVISCOMILL (trademark) from Aimex Co., Ltd.) filled with 80% by volume of zirconia beads having a diameter of 0.5 mm, at a liquid feeding speed of 1 kg/hour and a disc peripheral speed of 6 m/sec. This dispersing operation is repeated 3 times (3 passes). Further, 1,042 parts of a 65% ethyl acetate solution of the amorphous polyester 1 are added, and the resulting mixture is subjected to the above dispersing operation 1 time (1 pass). Thus, a dispersion 1 is prepared. The dispersion 1 is containing solid components in an amount of 50% by weight.

A 2-liter metallic vessel is charged with 100 g of the crystalline polyester 1 and 400 g of ethyl acetate. The mixture is heated to 75° C. to dissolve the crystalline polyester 1 in the ethyl acetate, followed by cooling in an ice water bath at a cooling rate of 27° C./min. After adding 500 ml of glass beads having a diameter of 3 mm to the vessel, the mixture in the vessel is subjected to a pulverization treatment for 10 hours using a batch-type sand mill apparatus (from Kanpe Hapio Co., Ltd.). Thus, a dispersion 2 is prepared.

In a vessel, 680 parts of the dispersion 1, 73.9 parts of the dispersion 2, 109.4 parts of the polyester prepolymer 1, and 4.6 parts of the ketimine 1 are mixed for 1 minute at a revolution of 5,000 rpm using a TK HOMOMIXER (from Primix Corporation). After adding 1,200 parts of the aqueous medium 1, the resulting mixture is further mixed for 25 minutes at a revolution of 13,000 rpm using the TK HOMOMIXER. Thus, an emulsion slurry is obtained.

The emulsion slurry is contained in a vessel equipped with a stirrer and a thermometer, and subjected to solvent removal for 8 hours at 30° C., and subsequent aging for 4 hours at 45° C., to obtain a dispersion slurry.

The dispersion slurry in an amount of 100 parts is filtered under reduced pressures, thus obtaining a wet cake (i). The wet cake (i) is mixed with 100 parts of water for 10 minutes at a revolution of 12,000 rpm using a TK HOMOMIXER (from Primix Corporation), followed by filtering, thus obtaining a wet cake (ii). The wet cake (ii) is mixed with 100 parts of a 10% aqueous solution of sodium hydroxide for 30 minutes at a revolution of 12,000 rpm using a TK HOMOMIXER (from Primix Corporation), followed by filtering under reduced pressures, thus obtaining a wet cake (iii). The wet cake (iii) is mixed with 100 parts of a 10% hydrochloric acid for 10 minutes at a revolution of 12,000 rpm using a TK HOMOMIXER (from Primix Corporation), followed by filtering, thus obtaining a wet cake (iv). The wet cake (iv) is mixed with 300 parts of water for 10 minutes at a revolution of 12,000 rpm using a TK HOMOMIXER (from Primix Corporation), followed by filtering. This operation is repeated twice, thus obtaining a wet cake (v). The wet cake (v) is dried by a drier for 48 hours at 45° C., and filtered with a mesh having openings of 75 μm. Thus, a mother toner is prepared.

The mother toner in an amount of 100 parts is mixed with 0.7 parts of a hydrophobized silica having an average particle diameter of 13 nm and 0.3 parts of a hydrophobized titanium oxide having an average particle diameter of 13 nm using a HENSCHEL MIXER. Thus, a toner 1 is prepared.

### Example 2

The procedures in Example 1 are repeated except for replacing the crystalline polyester 1 with the crystalline polyester 2.

### Example 3

The procedures in Example 1 are repeated except for replacing the crystalline polyester 1 with the crystalline polyester 3.

### Example 4

The procedures in Example 1 are repeated except for replacing the amorphous polyester 1 with the amorphous polyester 2.

### Example 5

The procedures in Example 1 are repeated except for replacing the amorphous polyester 1 with the amorphous polyester 3.

### Example 6

The procedures in Example 1 are repeated except for replacing the amorphous polyester 1 with the amorphous polyester 4.

### Example 7

The procedures in Example 1 are repeated except for replacing the crystalline polyester 1 with the crystalline polyester 7.

### Example 8

The procedures in Example 1 are repeated except for replacing the crystalline polyester 1 with the crystalline polyester 8.

### Example 9

The procedures in Example 1 are repeated except for replacing the crystalline polyester 1 with the crystalline polyester 9.

### Example 10

The procedures in Example 1 are repeated except for replacing the crystalline polyester 1 with the crystalline polyester 10.

### Example 11

The procedures in Example 1 are repeated except for replacing the crystalline polyester 1 with the crystalline polyester 11.

### Example 12

The procedures in Example 1 are repeated except for replacing the crystalline polyester 1 with the crystalline polyester 12.

### Example 13

A vessel equipped with a stirrer and a thermometer is charged with 226 parts of the amorphous polyester 1, 100 parts of a carnauba wax, and 947 parts of ethyl acetate. The mixture is heated to 80° C. for 5 hours and cooled to 30° C. over a period of 1 hour. The mixture is further mixed with 500 parts of the master batch and 500 parts of ethyl acetate for 1 hour. Thereafter, 1,324 parts of the resulting mixture are subjected to a dispersion treatment using a bead mill (ULTRAVISCOMILL (trademark) from Aimex Co., Ltd.) filled with 80% by volume of zirconia beads having a diameter of 0.5 mm, at a liquid feeding speed of 1 kg/hour and a disc peripheral speed of 6 m/sec. This dispersing operation is repeated 3 times (3 passes). Further, 1,042 parts of a 65% ethyl acetate solution of the amorphous polyester 1 are added, and the resulting mixture is subjected to the above dispersing operation 1 time (1 pass). Thus, a dispersion 3 is prepared.

The dispersion 2 prepared in Example 1 is mixed with 150 parts of the amorphous polyester 1 for 1 hour at 50° C. Thus, a dispersion 4 is prepared.

The procedures in Example 1 are repeated except for replacing the dispersions 1 and 2 with the dispersions 3 and 4, respectively.

### Example 14

The procedures in Example 1 are repeated except that the amount of the crystalline polyester is changed from 100 g to 300 g and the amorphous polyester 1 is replaced with the amorphous polyester 4.

### Example 15

The procedures in Example 1 are repeated except that the amount of the crystalline polyester is changed from 100 g to 510 g and the amorphous polyester 1 is replaced with the amorphous polyester 4.

### Example 16

The procedures in Example 1 are repeated except that the polyester prepolymer 1 is not mixed with the dispersions 1 and 2, and the amorphous polyester 1 is replaced with the amorphous polyester 4.

### Comparative Example 1

The procedures in Example 1 are repeated except that the crystalline polyester 1 is replaced with the crystalline polyester 4, the amount of the crystalline polyester is changed from 100 g to 610 g, and the amorphous polyester 1 is replaced with the amorphous polyester 3.

### Comparative Example 2

The procedures in Example 1 are repeated except for replacing the crystalline polyester 1 with the crystalline polyester 5.

### Comparative Example 3

The procedures in Example 1 are repeated except for replacing the crystalline polyester 1 with the crystalline polyester 6.

### Comparative Example 4

The procedures in Example 1 are repeated except for replacing the crystalline polyester 1 with the crystalline polyester 13.

### Comparative Example 5

The procedures in Example 1 are repeated except for replacing the crystalline polyester 1 with the crystalline polyester 14.

### Comparative Example 6

The procedures in Example 1 are repeated except for replacing the crystalline polyester 1 with the crystalline polyester 15.

Table 2 shows thermal properties of the above-prepared toners, i.e., glass transition temperatures determined from each differential scanning calorimetric curve of each toner obtained in a first heating of temperature-modulated differential scanning calorimetry, and heat quantities absorbed by each crystalline polyester in each toner when the toner is heated at a heating rate of 1° C./min in a first heating of temperature-modulated differential scanning calorimetry.

TABLE 2

| | | | Heat |
|---|---|---|---|
| | | Glass | quantity |
| | | transition | absorbed by |
| | Crystalline | temperature | crystalline |
| | polyester | of toner | polyester in |
| | No. | (° C.) | toner (J/g) |
| Example 1 | 1 | 53 | 10 |
| Example 2 | 2 | 53 | 10 |
| Example 3 | 3 | 53 | 10 |
| Example 4 | 1 | 62 | 10 |
| Example 5 | 1 | 47 | 10 |
| Example 6 | 1 | 58 | 10 |
| Example 7 | 7 | 53 | 10 |
| Example 8 | 8 | 53 | 10 |
| Example 9 | 9 | 53 | 10 |
| Example 10 | 10 | 53 | 10 |
| Example 11 | 11 | 53 | 10 |
| Example 12 | 12 | 53 | 10 |
| Example 13 | 1 | 44 | 3 |
| Example 14 | 1 | 58 | 28 |
| Example 15 | 1 | 58 | 53 |
| Example 16 | 1 | 60 | 10 |
| Comparative Example 1 | 4 | 43 | 60 |
| Comparative Example 2 | 5 | 53 | 10 |
| Comparative Example 3 | 6 | 53 | 10 |
| Comparative Example 4 | 13 | 53 | 10 |
| Comparative Example 5 | 14 | 53 | 10 |
| Comparative Example 6 | 15 | 53 | 10 |

The above-prepared toners are evaluated from the viewpoints of low-temperature fixability, heat-resistant storage stability, and filming resistance as follows.

### Low-Temperature Fixability

Each toner is set in a modified copier MF2200 (from Ricoh Co., Ltd.) employing a TEFLON® fixing roller in which the paper feed liner speed is set to 120-150 mm/sec, the surface pressure is set to 1.2 kgf/cm², and the nip width is set to 3 mm. The copier produces toner images on paper TYPE 6200 (from Ricoh Co., Ltd.) while varying the temperature of the fixing roller to determine the minimum fixable temperature. Low-temperature fixability of each toner is graded by minimum fixable temperature as follows.

A: less than 130° C.

B: not less than 130° C. and less than 134° C.

C: not less than 135° C. and less than 139° C.

D: not less than 140° C.

### Heat-Resistant Storage Stability

A 20-ml glass container is filled with 10 g of each toner and subjected to 100 times of tapping using a tapping apparatus. The container is then left in a constant heat chamber at a temperature of 50° C. and a humidity of 80% for 24 hours, followed by a penetration test using a penetration tester. Heat-resistant storage stability of each toner is graded by penetration as follows.

A: not less than 20 mm

B: not less than 15 mm and less than 20 mm

C: not less than 10 mm and less than 15 mm

D: less than 10 mm

### Filming Resistance

Each toner is set in a modified copier MF2200 (from Ricoh Co., Ltd.) employing a TEFLON® fixing roller. After the copier produces 500,000 sheets of an image having 10% of printing area, the photoreceptor drum is visually observed to determine whether filming occurs or not and to evaluate image quality. Filming resistance of each toner is graded by observation results as follows.

A: Filming does not occur. Normal image.

B: Slight filming occurs. Normal image.

C: Filming occurs. Normal image.

D: Filming occurs. Defective image.

The evaluation results are shown in Table 3.

TABLE 3

| | | Heat- | |
|---|---|---|---|
| | Low- | resistant | |
| | temperature | Storage | Filming |
| | Fixability | Stability | Resistance |
| Example 1 | A | A | A |
| Example 2 | A | B | B |
| Example 3 | B | A | A |
| Example 4 | B | A | A |
| Example 5 | A | B | A |
| Example 6 | B | A | A |
| Example 7 | B | A | B |
| Example 8 | A | A | A |
| Example 9 | A | A | A |
| Example 10 | B | A | A |
| Example 11 | B | A | A |
| Example 12 | B | A | A |
| Example 13 | A | C | B |
| Example 14 | A | A | B |
| Example 15 | A | B | C |
| Example 16 | A | B | B |
| Comparative Example 1 | A | D | C |
| Comparative Example 2 | D | A | A |
| Comparative Example 3 | A | D | B |
| Comparative Example 4 | D | A | A |
| Comparative Example 5 | D | A | A |
| Comparative Example 6 | A | D | B |

Additional modifications and variations of the present invention are possible in light of the above teachings. It is therefore to be understood that within the scope of the appended claims the invention may be practiced other than as specifically described herein.

What is claimed is:

1. A toner, comprising:
a colorant;
a release agent;
an amorphous polyester; and
a crystalline polyester having an endothermic peak temperature of 60 to 80° C. and an endothermic quantity of 3.0 to 20.0 J/g,
the endothermic peak temperature determined from a constant rate component curve of the crystalline polyester obtained in a second heating of temperature-modulated differential scanning calorimetry, and
the endothermic quantity determined from an area between the constant rate component curve and its base line drawn between 0 and 100° C., within a temperature range of 0 to 50° C.

2. The toner according to claim 1, wherein the toner has a glass transition temperature of 45 to 65° C.,
the glass transition temperature determined from a differential scanning calorimetric curve of the toner obtained in a first heating of temperature-modulated differential scanning calorimetry.

3. The toner according to claim 1, wherein the toner is manufactured by a method comprising:
dissolving or dispersing toner components comprising the colorant, the release agent, the amorphous polyester, and the crystalline polyester in an organic solvent, to prepare a toner components liquid; and
emulsifying or dispersing the toner components liquid in an aqueous medium.

4. The toner according to claim 1, further comprising resin particles on a surface of the toner.

5. The toner according to claim 1, wherein the crystalline polyester absorbs 5.0 to 50.0 J/g of heat when the toner is heated at a heating rate of 1° C./min in a first heating of temperature-modulated differential scanning calorimetry.

6. The toner according to claim 1, wherein the amorphous polyester comprises a urea-modified polyester.

7. The toner according to claim 1, wherein the amorphous polyester consists essentially of an alcohol component selected from the group consisting of 1,4-butanediol, 1,6-hexanediol, 1,8-octanediol, 1,10-decanediol, and 1,12-dodecanediol and an acid component selected from the group consisting of fumaric acid, 1,4-butanedioic acid, 1,6-hexanedioic acid, 1,8-octanedioic acid, 1,10-decanedioic acid, and 1,12-dodecanedioic acid.

8. A method of manufacturing the toner according to claim 1, comprising:
dissolving or dispersing toner components comprising the colorant, the release agent, the amorphous polyester, and the crystalline polyester in an organic solvent, to prepare a first liquid;
emulsifying or dispersing the first liquid in an aqueous medium including a particulate resin to prepare a second liquid; and
removing the organic solvent from the second liquid.

9. A method of manufacturing the toner according to claim 1, comprising:
dissolving or dispersing toner components comprising the colorant, the release agent, the crystalline polyester, a polyester prepolymer having an isocyanate group, and a compound having an amino group in an organic solvent, to prepare a first liquid;
emulsifying or dispersing the first liquid in an aqueous medium including a particulate resin to prepare a second liquid; and
removing the organic solvent from the second liquid.

10. A developer, comprising the toner according to claim 1.

11. An image forming method, comprising:
charging a photoreceptor;
irradiating the charged photoreceptor with light to form an electrostatic latent image;
developing the electrostatic latent image into a toner image with the developer according to claim 10;
transferring the toner image from the photoreceptor onto a recording medium; and
fixing the toner image on the recording medium.

12. An image forming apparatus, comprising:
a charger to charge a photoreceptor;
an irradiator to irradiate the charged photoreceptor with light to form an electrostatic latent image;
a developing device including the developer according to claim 10 to develop the electrostatic latent image into a toner image;
a transfer device to transfer the toner image from the photoreceptor onto a recording medium; and
a fixing device to fix the toner image on the recording medium.
